(19) United States
(12) Patent Application Publication
(10) Pub. No.: US 2016/0125469 A1
(43) Pub. Date: May 5, 2016

(54) SELECTION OF A GROUP OF CONTENT ITEMS FOR PRESENTATION TO AN ONLINE SYSTEM USER BASED ON CONTENT ITEM CHARACTERISTICS AND USER ATTRIBUTES

(71) Applicant: Facebook, Inc., Menlo Park, CA (US)

(72) Inventor: Erick Tseng, San Francisco, CA (US)

(21) Appl. No.: 14/529,133

(22) Filed: Oct. 30, 2014

(51) Int. Cl. G06Q 30/02; G06F 17/30; H04L 29/06

(52) U.S. Cl. CPC G06Q 30/0269; H04L 67/42; G06F 17/30598; G06F 17/30386; G06Q 30/0261

(57) ABSTRACT

An online system presents content items to a user. Each content item is associated with one or more characteristics, such as a geographic location. To simplify user interaction, the online system identifies content items each having a characteristic having at least a threshold measure of similarity to an attribute of the user and generates a content unit including the content items. The content unit includes a display area presenting a content item and is configured to present an alternative content item if an interaction with the content unit is detected. Content items included in the content unit may include advertisements and stories describing actions associated with additional users of the online system.

### BACKGROUND

This disclosure relates generally to presentation of content items to an online system user, and more specifically to identifying multiple content items for presentation to the online system user based on characteristics of the content items and attributes of the user.

An online system, such as a social networking system, allows its users to connect to and communicate with other users. Users may create profiles on an online system that are tied to their identities and include information about the users, such as interests and demographic information. The users may be individuals or entities such as corporations or charities. Establishing connections with other users via an online system allows a user to more easily share content with the other users. When the online system receives an interaction with content from a user, the online system stores information describing the interaction and may generate a content item describing the interaction that is presented to other online system users connected to the user in a feed of content items. Presenting users with content items describing interactions may increase user interaction with the online system.

Additionally, entities (e.g., a business) may present content items to online system users to gain public attention for products or services or to persuade online system users to take an action regarding products or services provided by the entity. Many online systems may receive compensation from an entity for presenting certain types of content items provided by the entity to online system users. Frequently, online systems charge an entity for each presentation of certain types of content to an online system user (e.g., each “impression” of the content) or for each interaction with the certain types of content by online system users.

As a user interacts with an online system and as the online system accumulates content items, the online system may present an increasing number of content items to a user. Additionally, multiple content items may be relevant to a user at a particular time or may be relevant for a particular reason; however, conventional online systems often present content items based on their individual relevance to a user, so the multiple content items may be presented at different times or presented in disparate locations to the user. This may make it difficult for a user to identify content items relevant to the user at a particular time or for a particular reason, which may impair user interaction with the online system.

### SUMMARY

An online system selects one or more content items for communication to a client device to be presented to a user. In various embodiments, the online system generates a content unit that includes a display area presenting a content item and including multiple content items having a characteristic that has at least a threshold measure of similarity to one or more attributes of the user. For example, the online system selects content items having a characteristic with at least a threshold measure of similarity to an attribute associated with the user and includes a set of the content items in the content unit. Further, the content unit is configured to present an alternative content item included in the content unit when an interaction with the content unit is detected or identified.

Content items selected for inclusion in a content unit include advertisements, stories describing actions associated with additional users connected to the user via the online system, or any other suitable content. Characteristics associated with a content item include: a geographic location, a time, a group, an event, and a topic. Attributes of a user include: a geographic location associated with the user, a time associated with the user, an event associated with the user (e.g., an event that the user has indicated it will attend), a group associated with the user (e.g., a group including the user as a member of the group), one or more interests associated with the user, and a status associated with the user. Some attributes of a user may be determined by the online system based on content provided to the online system by the user. For example, based on content received from the user, the online system may determine that the user is travelling or is planning to travel and stores an attribute associated with the user indicating the user is traveling.

The online system generates measures of similarity between characteristics associated with various content items and selects content items as content items associated with a characteristic having at least a threshold measure of similarity to an attribute of the user. For example, content items associated with a location within a threshold distance of a location associated with the user are selected as content items, content items associated with at least a threshold number of topics matching interests associated with the user are identified as content items, or content items associated with a time within a threshold interval of a time associated with the user are identified as content items. In one embodiment, the online system includes content items associated with a common characteristic having at least the threshold measure of similarity to an attribute of the user in a content unit (e.g., content items associated with a location within a threshold distance of a location associated with the user) and communicates the content unit to a client device 110 for presentation to the user. In certain embodiments, the online system may include different types of content items in the content unit. For example, at least one story describing an action associated with an additional user is included in the content unit along with advertisements or other types of content items.

### BRIEF DESCRIPTION OF THE DRAWINGS

FIG. 1 is a block diagram of a system environment in which an online system operates, in accordance with an embodiment.

FIG. 2 is a block diagram of an online system, in accordance with an embodiment.

FIG. 3 is a flowchart of one embodiment of a method for generating a group of content items for presentation to a user of an online system, in accordance with an embodiment.

FIG. 4 is example of presenting content items having a characteristic having at least a threshold measure of similarity to an attribute of an online system user.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

### System Architecture

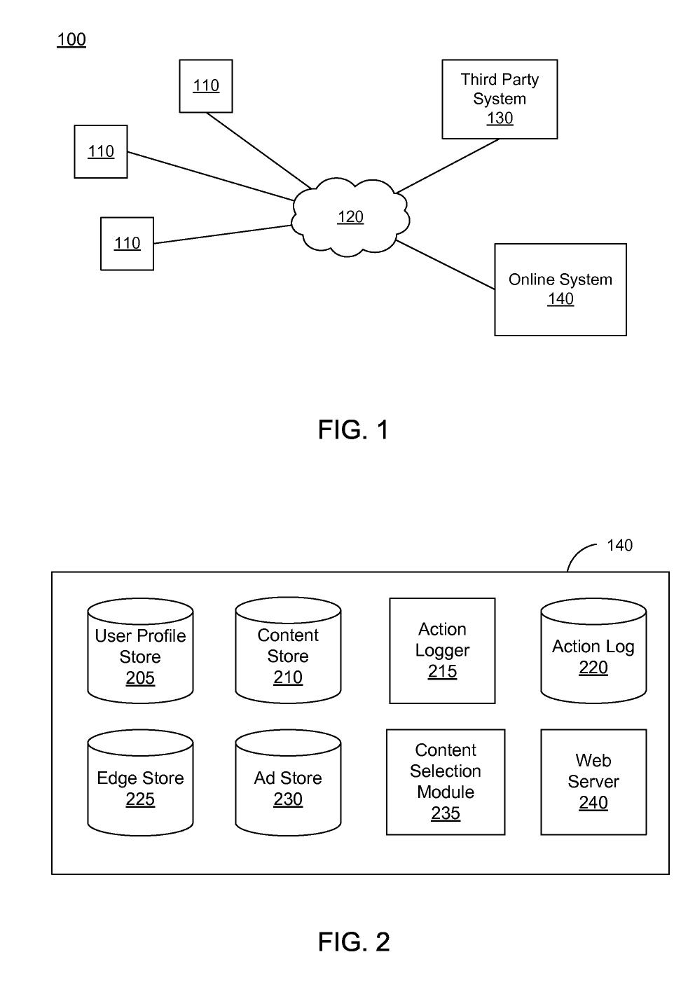

FIG. 1 is a block diagram of a system environment 100 for an online system 140. The system environment 100 shown by FIG. 1 comprises one or more client devices 110, a network 120, one or more third-party systems 130, and the online system 140. In alternative configurations, different and/or additional components may be included in the system environment 100. The embodiments described herein can be adapted to online systems that are not social networking systems.

The client devices 110 are one or more computing devices capable of receiving user input as well as transmitting and/or receiving data via the network 120. In one embodiment, a client device 110 is a conventional computer system, such as a desktop or a laptop computer. Alternatively, a client device 110 may be a device having computer functionality, such as a personal digital assistant (PDA), a mobile telephone, a smartphone or another suitable device. A client device 110 is configured to communicate via the network 120. In one embodiment, a client device 110 executes an application allowing a user of the client device 110 to interact with the online system 140. For example, a client device 110 executes a browser application to enable interaction between the client device 110 and the online system 140 via the network 120. In another embodiment, a client device 110 interacts with the online system 140 through an application programming interface (API) running on a native operating system of the client device 110, such as IOS® or ANDROID™.

The client devices 110 are configured to communicate via the network 120, which may comprise any combination of local area and/or wide area networks, using both wired and/or wireless communication systems. In one embodiment, the network 120 uses standard communications technologies and/or protocols. For example, the network 120 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 120 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 120 may be encrypted using any suitable technique or techniques.

One or more third party systems 130 may be coupled to the network 120 for communicating with the online system 140, which is further described below in conjunction with FIG. 2. In one embodiment, a third party system 130 is an application provider communicating information describing applications for execution by a client device 110 or communicating data to client devices 110 for use by an application executing on the client device. In other embodiments, a third party system 130 provides content or other information for presentation via a client device 110. A third party system 130 may also communicate information to the online system 140, such as advertisements, content, or information about an application provided by the third party system 130.

FIG. 2 is a block diagram of an architecture of the online system 140. The online system 140 shown in FIG. 2 includes a user profile store 205, a content store 210, an action logger 215, an action log 220, an edge store 225, and advertisement (“ad”) request store 230, a content selection module 235, and a web server 240. In other embodiments, the online system 140 may include additional, fewer, or different components for various applications. Conventional components such as network interfaces, security functions, load balancers, failover servers, management and network operations consoles, and the like are not shown so as to not obscure the details of the system architecture.

Each user of the online system 140 is associated with a user profile, which is stored in the user profile store 205. A user profile includes declarative information about the user that was explicitly shared by the user and may also include profile information inferred by the online system 140. In one embodiment, a user profile includes multiple data fields, each describing one or more attributes of the corresponding social networking system user. Examples of information stored in a user profile include biographic, demographic, and other types of descriptive information, such as work experience, educational history, gender, hobbies or preferences, location and the like. A user profile may also store other information provided by the user, for example, images or videos. In certain embodiments, images of users may be tagged with information identifying the social networking system users displayed in an image. A user profile in the user profile store 205 may also maintain references to actions by the corresponding user performed on content items in the content store 210 and stored in the action log 220.

While user profiles in the user profile store 205 are frequently associated with individuals, allowing individuals to interact with each other via the online system 140, user profiles may also be stored for entities such as businesses or organizations. This allows an entity to establish a presence on the online system 140 for connecting and exchanging content with other social networking system users. The entity may post information about itself, about its products or provide other information to users of the social networking system using a brand page associated with the entity's user profile. Other users of the social networking system may connect to the brand page to receive information posted to the brand page or to receive information from the brand page. A user profile associated with the brand page may include information about the entity itself, providing users with background or informational data about the entity.

The content store 210 stores objects that each represent various types of content. Examples of content represented by an object include a page post, a status update, a photograph, a video, a link, a shared content item, a gaming application achievement, a check-in event at a local business, a brand page, or any other type of content. Social networking system users may create objects stored by the content store 210, such as status updates, photos tagged by users to be associated with other objects in the online system 140, events, groups or applications. In some embodiments, objects are received from third-party applications or third-party applications separate from the online system 140. In one embodiment, objects in the content store 210 represent single pieces of content, or content “items.” Hence, social networking system users are encouraged to communicate with each other by posting text and content items of various types of media to the online system 140 through various communication channels. This increases the amount of interaction of users with each other and increases the frequency with which users interact within the online system 140.

The action logger 215 receives communications about user actions internal to and/or external to the online system 140, populating the action log 220 with information about user actions. Examples of actions include adding a connection to another user, sending a message to another user, uploading an image, reading a message from another user, viewing content associated with another user, and attending an event posted by another user. In addition, a number of actions may involve an object and one or more particular users, so these actions are associated with those users as well and stored in the action log 220.

The action log 220 may be used by the online system 140 to track user actions on the online system 140, as well as actions on third party systems 130 that communicate information to the online system 140. Users may interact with various objects on the online system 140, and information describing these interactions is stored in the action log 220. Examples of interactions with objects include: commenting on posts, sharing links, checking-in to physical locations via a mobile device, accessing content items, and any other suitable interactions. Additional examples of interactions with objects on the online system 140 that are included in the action log 220 include: commenting on a photo album, communicating with a user, establishing a connection with an object, joining an event, joining a group, creating an event, authorizing an application, using an application, expressing a preference for an object (“liking” the object), and engaging in a transaction. Additionally, the action log 220 may record a user's interactions with advertisements on the online system 140 as well as with other applications operating on the online system 140. In some embodiments, data from the action log 220 is used to infer interests or preferences of a user, augmenting the interests included in the user's user profile and allowing a more complete understanding of user preferences.

The action log 220 may also store user actions taken on a third party system 130, such as an external website, and communicated to the online system 140. For example, an e-commerce website may recognize a user of an online system 140 through a social plug-in enabling the e-commerce website to identify the user of the online system 140. Because users of the online system 140 are uniquely identifiable, e-commerce websites, such as in the preceding example, may communicate information about a user's actions outside of the online system 140 to the online system 140 for association with the user. Hence, the action log 220 may record information about actions users perform on a third party system 130, including webpage viewing histories, advertisements that were engaged, purchases made, and other patterns from shopping and buying.

In one embodiment, the edge store 225 stores information describing connections between users and other objects on the online system 140 as edges. Some edges may be defined by users, allowing users to specify their relationships with other users. For example, users may generate edges with other users that parallel the users' real-life relationships, such as friends, co-workers, partners, and so forth. Other edges are generated when users interact with objects in the online system 140, such as expressing interest in a page on the online system 140, sharing a link with other users of the online system 140, and commenting on posts made by other users of the online system 140.

In one embodiment, an edge may include various features each representing characteristics of interactions between users, interactions between users and objects, or interactions between objects. For example, features included in an edge describe rate of interaction between two users, how recently two users have interacted with each other, the rate or amount of information retrieved by one user about an object, or the number and types of comments posted by a user about an object. The features may also represent information describing a particular object or user. For example, a feature may represent the level of interest that a user has in a particular topic, the rate at which the user logs into the online system 140, or information describing demographic information about a user. Each feature may be associated with a source object or user, a target object or user, and a feature value. A feature may be specified as an expression based on values describing the source object or user, the target object or user, or interactions between the source object or user and target object or user; hence, an edge may be represented as one or more feature expressions.

The edge store 225 also stores information about edges, such as affinity scores for objects, interests, and other users. Affinity scores, or “affinities,” may be computed by the online system 140 over time to approximate a user's interest in an object or in another user in the online system 140 based on the actions performed by the user. A user's affinity may be computed by the online system 140 over time to approximate the user's interest in an object, a topic, or another user in the online system 140 based on actions performed by the user. Computation of affinity is further described in U.S. patent application Ser. No. 12/978,265, filed on Dec. 23, 2010, U.S. patent application Ser. No. 13/690,254, filed on Nov. 30, 2012, U.S. patent application Ser. No. 13/689,969, filed on Nov. 30, 2012, and U.S. patent application Ser. No. 13/690,088, filed on Nov. 30, 2012, each of which is hereby incorporated by reference in its entirety. Multiple interactions between a user and a specific object may be stored as a single edge in the edge store 225, in one embodiment. Alternatively, each interaction between a user and a specific object is stored as a separate edge. In some embodiments, connections between users may be stored in the user profile store 205, or the user profile store 205 may access the edge store 225 to determine connections between users.

One or more advertisement requests (“ad requests”) are included in the ad request store 230. An advertisement request includes advertisement content and a bid amount. The advertisement content is text, image, audio, video, or any other suitable data presented to a user. In various embodiments, the advertisement content also includes a landing page specifying a network address to which a user is directed when the advertisement is accessed. The bid amount is associated with an ad request by an advertiser and is used to determine an expected value, such as monetary compensation, provided by an advertiser to the online system 140 if advertisement content in the ad request is presented to a user, if the advertisement content in the ad request receives a user interaction when presented. For example, the bid amount specifies a monetary amount that the online system 140 receives from the advertiser if advertisement content in an ad request is displayed and the expected value is determined by multiplying the bid amount by a probability of the advertisement content being accessed.

Additionally, an advertisement request may include one or more targeting criteria specified by the advertiser. Targeting criteria included in an advertisement request specify one or more characteristics of users eligible to be presented with advertisement content in the advertisement request. For example, targeting criteria are used to identify users having user profile information, edges or actions satisfying at least one of the targeting criteria. Hence, targeting criteria allow an advertiser to identify users having specific characteristics, simplifying subsequent distribution of content to different users.

In one embodiment, targeting criteria may specify actions or types of connections between a user and another user or object of the online system 140. Targeting criteria may also specify interactions between a user and objects performed external to the online system 140, such as on a third party system 130. For example, targeting criteria identifies users that have taken a particular action, such as sending a message to another user, using an application, joining a group, leaving a group, joining an event, generating an event description, purchasing or reviewing a product or service using an online marketplace, requesting information from a third-party system 130, or any other suitable action. Including actions in targeting criteria allows advertisers to further refine users eligible to be presented with content from an advertisement request. As another example, targeting criteria identifies users having a connection to another user or object or having a particular type of connection to another user or object.

The content selection module 235 selects one or more content items for communication to a client device 110 to be presented to a user. In various embodiments, the content selection module 235 generates a content unit that includes a display area presenting a content item and including multiple content items having a characteristic that has at least a threshold measure of similarity to one or more attributes of the user. For example, the content selection module 235 selects content items having a characteristic with at least a threshold measure of similarity to an attribute associated with the user and includes a set of the content items in the content unit. Further, the content unit is configured to present an alternative content item included in the content unit when an interaction with the content unit is detected or identified.

Content items selected for inclusion in a content unit include advertisements, stories describing actions associated with additional users connected to the user via the online system 140, or any other suitable content. Characteristics associated with a content item include: a geographic location, a time, a group, an event, and a topic. Attributes of a user include: a geographic location associated with the user, a time associated with the user, an event associated with the user (e.g., an event that the user has indicated it will attend), a group associated with the user (e.g., a group including the user as a member of the group), one or more interests associated with the user, and a status associated with the user. Attributes of the user may be retrieved from the user profile store 205 or from any other suitable component of the online system 140.

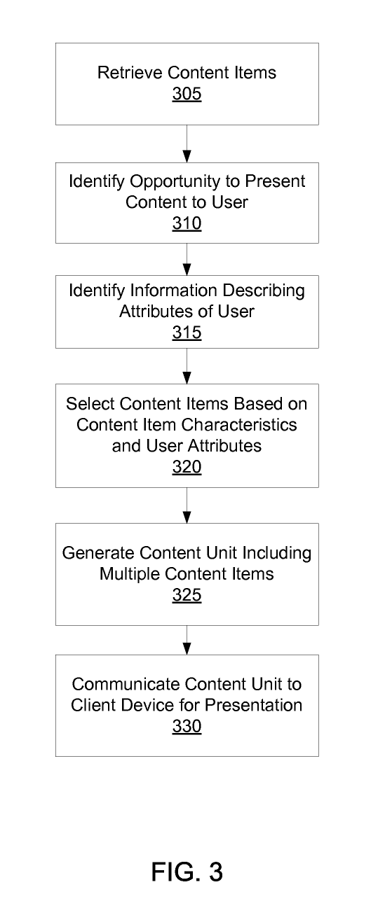

As further described below in conjunction with FIG. 3, the content selection module 235 generates measures of similarity between characteristics associated with various content items and selects content items as content items associated with a characteristic having at least a threshold measure of similarity to an attribute of the user. For example, content items associated with a location within a threshold distance of a location associated with the user are selected as content items, content items associated with at least a threshold number of topics matching interests associated with the user are identified as content items, or content items associated with a time within a threshold interval of a time associated with the user are identified as content items. In one embodiment, the content selection module 235 includes content items associated with a common characteristic having at least the threshold measure of similarity to an attribute of the user in a content unit (e.g., content items associated with a location within a threshold distance of a location associated with the user) an communicates the content unit to a client device 110 for presentation to the user. Generation of a content unit is further described below in conjunction with FIG. 3.

The web server 240 links the online system 140 via the network 120 to the one or more client devices 110, as well as to the one or more third party systems 130. The web server 240 serves web pages, as well as other content, such as JAVA®, FLASH®, XML and so forth. The web server 240 may receive and route messages between the online system 140 and the client device 110, for example, instant messages, queued messages (e.g., email), text messages, short message service (SMS) messages, or messages sent using any other suitable messaging technique. A user may send a request to the web server 240 to upload information (e.g., images or videos) that are stored in the content store 210. Additionally, the web server 240 may provide application programming interface (API) functionality to send data directly to native client device operating systems, such as IOS®, ANDROID™, WEBOS® or BlackberryOS.

### Selecting Content Items for Presentation to an Online System User

FIG. 3 is a flowchart of one embodiment of a method for generating a group of content items for presentation to a user of an online system 140. In other embodiments, the steps described in conjunction with FIG. 3 may be performed in different orders than the one described in conjunction with FIG. 3. Additionally, the method may include different and/or additional steps than the steps described in conjunction with FIG. 3 in some embodiments.

The online system 140 retrieves 305 one or more content items each associated with one or more characteristics. Examples of content items include a story describing an action associated with an additional user connected to the user via the online system 140 and advertisements included in one or more advertisement requests (“ad requests”) maintained by the online system 140 or retrieved 305 from a third party system 130. Characteristics associated with a content item may be specified by an entity associated with the content item, may be specified by an entity from which the content item was received, or may be determined by the online system 140 based on information associated with the content item 140. Examples of characteristics associated with a content item include: a geographic location, a time, a group, an event, and a topic.

For example, an advertiser associates a geographic location with an advertisement, such as a geographic location of a merchant, restaurant, or retailer. An example of an advertisement including a geographic location associated with content of the advertisement is further described in U.S. patent application Ser. No. 14/305,997, filed on Jun. 16, 2014, which is hereby incorporated by reference in its entirety. Similarly, the advertiser may associate a time with the advertisement, such as a time associated with a promotion described by the advertisement. As another example, the advertiser associates one or more topics associated with the advertisement to identify a product or service being advertised or a product or service provided by the advertiser. Alternatively, the online system 140 analyzes content included in an advertisement and associates one or more topics with the advertisement. Similarly, an additional user who generated a content item may associate a geographic location or a time with the content item (e.g., a geographic location and time associated with an event). As another example, online system 140 analyzes content included in the content item to identify one or more topics associated with the content item, as further described in U.S. application Ser. No. 13/167,701, filed Jun. 24, 2011, which is hereby incorporated by reference in its entirety.

When the online system 140 identifies 310 an opportunity to present content to the user, the online system 140 identifies 315 information maintained by the online system 140 and describing one or more attributes of the user. For example, the online system 140 identifies 310 an opportunity to present one or more advertisements to the user, the online system 140 identifies 315 the information describing one or more attributes of the user. An opportunity to present one or more advertisement users may be identified 310 when the online system 140 receives a request for one or more advertisements from a client device 110 associated with the user. Alternatively, an opportunity to present content to the user is identified 140 when the online system 140 receives a request for content from the client device 110 associated with the user, such as a request to refresh content previously provided to the client device 110 for presentation to the user.

Example attributes of the user include: a geographic location associated with the user, a time associated with the user, an event associated with the user (e.g., an event that the user has indicated it will attend), a group associated with the user (e.g., a group including the user as a member of the group), one or more interests associated with the user, and a status associated with the user. Attributes of the user may be included in a user profile associated with the user or may be associated with the user profile associated with the user. Attributes may be specified by the user or determined by the online system 140 based on information associated with the user by the online system 140. For example, the user identifies one or more interests in its associated user profile; additionally, the online system 140 may associate one or more interests with the user's user profile based on actions associated with the user by the online system 140 or content provided to the online system 140 by the user.

Additionally, the online system 140 may determine a status associated with the user as an attribute of the user. For example, the online system 140 determines the user is traveling if a difference between a current location associated with the user and a home location specified by the user differ or if content provided to the online system 140 by the user include terms or phrases associated with traveling. Whether the user is traveling may be an attribute of the user determined by the online system 140. Determination of whether a user is traveling is further described in conjunction with U.S. patent application Ser. No. 14/301,592, filed on Jun. 11, 2014, which is hereby incorporated by reference in its entirety.

Based on the characteristics associated with the identified content items and the attributes of the user, the online system 140 selects 320 multiple content items for presentation to the user. Each of the selected content items is associated with at least one common characteristic (e.g., a common location, a common topic, a common time). To provide the user with content items most likely to be relevant, the online system 140 selects 320 content items as content items associated with one or more characteristics having at least a threshold measure of similarity to at least one attribute of the user. For example, a measure of similarity for a geographic location associated with a content item is a distance between the geographic location associated with the content item and a geographic location associated with the user, with the measure of similarity inversely proportional to the distance (i.e., a smaller distance between the geographic location associated with the content item and the geographic location associated with the user results in a larger measure of similarity). Hence, content items associated with geographic locations within a threshold distance of a geographic location associated with the user are selected 320 as content items. For example, the social networking system 140 determines the user's current location is in New York City, so the social networking system 140 selects 320 content items associated with location information within a threshold distance (e.g., 50 miles) of New York City.

A geographic location associated with the user may be associated with a time subsequent to a current time, and the online system 140 selects 320 content items associated with a geographic location having at least a threshold likelihood to be within a threshold distance of the geographic location associated with the user within a time interval as advertisements. For example, based on content provide to the online system 140 by a user, the online system 140 identifies a location likely to be associated with the user at a time subsequent to a current time (e.g., a geographic location of a vacation planned by the user for a future date, a geographic location of a trip planned by the user for a future date). Based on a time or a time interval and a location associated with various content items, as well as attributes of the user and other characteristics of the user, the online system 140 determines likelihoods of the user being associated with a geographic location within a threshold distance of a geographic location associated with a content item at a time within a threshold time interval of a time associated with the content item. Information included in content provided to the online system 140 by the user, such as words or phrases included in content, may be used by the online system 140 to determine a likelihood of the user being within a threshold distance of a geographic location at a time interval specified by the user or determined from content associated with the user.

In various embodiments, measures of similarity between characteristics of various content items and attributes of users may be determined and used to select 320 content items. For example, content items associated with topics matching an interest of the user or an alternative interest associated with the interest of the user are determined to have at least the threshold measure of similarity with the interest and are selected 320 as content items. In one instance, the social networking system 140 determines that the user has expressed interest in or has greater than a threshold affinity to the topic “coffee,” so the social networking system 140 selects 320 content items (which may include both stories and advertisements) associated with the topic “coffee.” The online system 140 may maintain associations between interests in the content store 210 and determine a topic associated with a content item has at least the threshold measure of similarity with an interest if the topic matches at least a threshold number of the interests associated with the interest. A measure of similarity between a time associated with a content item and a time associated with the user may be inversely proportional to a difference between the time associated with the content item and the time associated with the user, so content items associated with times having less than a threshold distance between the time associated with the user are determined to have at least the threshold measure of similarity. The measure of similarity between characteristics of a content item and attributes of a user may be based on multiple characteristics of the content item and attributes of the user in some embodiments. For example, the measure of similarity between characteristics of a content item and attributes of a user is based on a combination of comparisons of multiple characteristics of the content item and attributes of the user (e.g., a weighted average of various comparisons), as described above. In one embodiment, the selected content items have a common characteristic that has at least a threshold measure of similarity to an attribute of the user, so the selected content items may each have a common characteristic having at least the threshold measure of similarity to an attribute of the user. In one embodiment, the selected content items each have a particular characteristic that has at least the threshold measure of similarity to an attribute of the user. For example, each selected content item is associated with a geographic location within a threshold distance of a location associated with the user or is associated with a topic matching an interest of the user.

The online system 140 generates 325 a content unit including the content items, or including a set of the content items, which is communicated 330 to a client device 110 for presentation to the user. One example of a content unit is further described in U.S. patent application Ser. No. 13/915,438, filed on Jun. 11, 2013, which is hereby incorporated by reference in its entirety. In some embodiments, a content unit including at least a threshold number of advertisements is referred to as an “advertisement unit.” Different types of content items may be included in the content unit. For example, the content unit includes one or more advertisements as well as one or more stories describing actions associated with additional users connected to the user via the online system. A threshold number of a certain type of content item may be included in the content unit to increase a likelihood of the user interacting with the content unit. The content unit includes a display area for presenting a content item and is configured to present an alternative content item if a type of user interaction with the content item is detected. For example, if the user performs a type of gesture with a portion of a display device presenting the content unit, an alternative content item included in the content unit is displayed via the display area of the content unit rather than a content item currently displayed via the display area of the content unit. Different interactions with the content unit may cause presentation of different alternative content items; for example, a type of gesture causes presentation of an alternative content item while another type of gesture causes presentation of a different alternative content item.

An order may be associated with content items included in a content unit to specify presentation of content items in the display area of the content unit. The order may be based on the measures of similarity between characteristics of content items and attributes of the user. In some embodiments, the order may be based at least in part on types of content items. For example, one or more rules may specify presentation of a type of content item (e.g., a story describing an action associated with an additional user connected to the user via the online system 140) after a threshold number of another type of content item (e.g., advertisements) have been presented by the display area of the content unit.

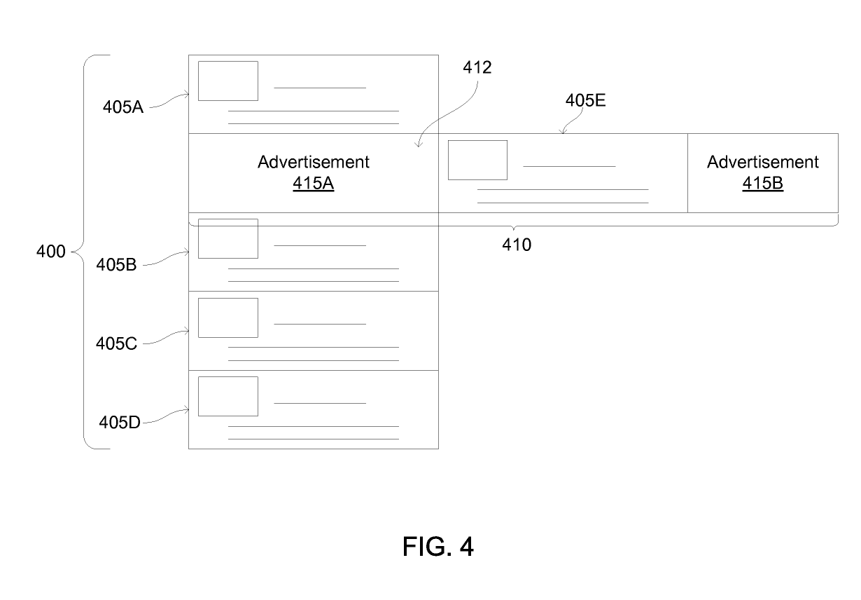

FIG. 4 is an example of presenting content items having a characteristic having at least a threshold measure of similarity to an attribute of a user to the user via a content unit. In the example of FIG. 4, content items are presented via a feed 400. For example, the feed 400 includes content items 405A, 405B, 405C, 405D (also referred to individually and collectively using reference number 405). The content items 405 may include stories describing actions associated with additional users connected to the user via the online system 140, advertisements, or any other suitable type of content.

In the example of FIG. 4, the feed 400 includes a content unit 410 including advertisements 415A, 415B (also referred to individually and collectively using reference number 415) and content item 405E. Advertisements 415A, 415B and content item 405E are selected for inclusion in the content unit 410 as described above in conjunction with FIG. 3. In the example of FIG. 4, the feed 400 is a vertically scrolling feed of content items and the content unit 410 is configured to horizontally scroll through advertisements 415A, 415B and content item 405E in response to one or more interactions with the content unit 410. For example, advertisements 415A, 415B and content item 405E are each associated with a geographic location within a threshold distance of a geographic location associated with the user. As described above in conjunction with FIG. 3, advertisements 415A, 415B and content item 405E are each associated with a common characteristic having at least a threshold measure of similarity to an attribute of the user. The content unit 410 includes a display area 412 in which content included in the content unit 410 is presented. Hence, the display area 412 of the content unit 410 is a region of the content unit 410 in which content is included for presentation via a display device. In FIG. 4, advertisement 415A is included in the display area 412 of the content unit 410, so it is displayed along with content items 405A, 405B, 405C, 405D in the feed 410. If the user interacts with the content unit 410 (e.g., performs a gesture with a portion of a display device corresponding to the display area 412, interacts with an interface element presented via the display area 412), content item 405E is presented by the display area 412 in place of advertisement 415A. As described above in conjunction with FIG. 3, different types of interactions with the content unit 410 may cause presentation of different content included in the content unit 410 via the display area 412. While FIG. 4 shows an example where the content unit 410 includes advertisements 415 and other content units 405, in other embodiments, the content unit 410 may include a single type of content item (e.g., advertisements).

### SUMMARY

The foregoing description of embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe embodiments in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of embodiments is intended to be illustrative, but not limiting, of the scope of the patent rights, which is set forth in the following claims.

What is claimed is:

1. A method comprising:
retrieving one or more advertisements at an online system, each advertisement associated with one or more geographic locations;
identifying an opportunity to serve an advertisement to a user of the online system;
identifying information maintained by the online system and describing one or more attributes of the user including a geographic location associated with the user;
selecting a plurality of advertisements from the one or more advertisements based at least in part on the geographic locations associated with the one or more advertisements and the geographic location associated with the user;
generating an advertisement unit including the selected advertisements, the advertisement unit including a display area for presenting a selected advertisement and configured to present an alternative selected advertisement in the display area in response to detecting a user interaction with the advertisement unit; and
communicating the advertisement unit to a client device for presentation to the user.

2. The method of claim 1, wherein selecting the plurality of advertisements from the one or more advertisements based at least in part on the geographic locations associated with the one or more advertisements and the geographic location associated with the user comprises:
selecting advertisements associated with a geographic location within a threshold distance of the geographic location associated with the user.

3. The method of claim 1, wherein selecting the plurality of advertisements from the one or more advertisements based at least in part on the geographic locations associated with the one or more advertisements and the geographic location associated with the user comprises:
selecting advertisements associated with a geographic location having at least a threshold likelihood to be within a threshold distance of the geographic location associated with the user within a time interval.

4. The method of claim 2, wherein the time interval is determined from information associated with the user.

5. The method of claim 4, wherein the information associated with the user includes content provided to the online system by the user.

6. The method of claim 1, wherein selecting the plurality of advertisements from the one or more advertisements based at least in part on the geographic locations associated with the one or more advertisements and the geographic location associated with the user comprises:
identifying one or more interests associated with the user from the information associated with the user;
identifying a topic associated with at least a set of the one or more advertisements; and
selecting an advertisement in the set associated with an interest matching at least one topic associated with the user and associated with a geographic location within a threshold distance of the geographic location associated with the user.

7. The method of claim 1, wherein the geographic location associated with the user comprises a geographic location associated with the user at a time subsequent to a current time.

8. The method of claim 1, wherein generating the advertisement unit including the advertisements comprises:
identifying one or more content items eligible for presentation to the user; and
including one or more content items in the advertisement unit.

9. The method of claim 8, wherein the one or more content items include one or more stories describing an action performed by an additional user connected to the user via the online system.

10. The method of claim 1, wherein the advertisement unit is presented in a vertically scrolling feed of content items and is configured to horizontally scroll through the selected advertisement units in response to the interaction with the advertisement unit.

11. A method comprising:
retrieving one or more content items maintained by an online system, each content item associated with one or more characteristics;
identifying an opportunity to serve content to a user of the online system;
identifying information maintained by the online system and describing one or more attributes of the user;
selecting a plurality of content items from the one or more content items based at least in part on the one or more characteristics associated with the one or more content items and the one or more attributes of the user, the plurality of content items having a common characteristic;
generating a content unit including the selected plurality of content items, the content unit including a display area for presenting a selected content item and configured to present an alternative selected content item in the display area in response to detecting a user interaction with the content unit; and
communicating the content unit to a client device for presentation to the user.

12. The method of claim 11, wherein the selected plurality of content items include one or more advertisements and one or more stories describing one or more actions associated with one or more additoianl users connected to the user via the online system.

13. The method of claim 11, wherein the one or more characteristics associated with a content item are selected from a group consisting of: a geographic location, a topic, an event, a group, a time, and any combination thereof.

14. The method of claim 11, wherein the one or more attributes associated with the user are selected from: a geographic location associated with the user, a time associated with the user, an event associated with the user, a group associated with the user, an interest associated with the user, and any combination thereof.

15. The method of claim 11, wherein an attribute associated with the user is determined based at least in part on content provided to the online system by the user.

16. The method of claim 11, wherein selecting the plurality of content items from the one or more content items based at least in part on the one or more characteristics associated with the one or more content items and the one or more attributes of the user comprises:
selecting a content item associated with at least a threshold number of characteristics having at least a threshold similarity to one or more attributes of the user.

17. A computer program product comprising a computer readable storage medium having instructions encoded thereon that, when executed by a processor, cause the processor to:
retrieve one or more content items maintained by an online system, each content item associated with one or more characteristics;
identify an opportunity to serve content to a user of the online system;
identify information maintained by the online system and describing one or more attributes of the user;
select a plurality of content items from the one or more content items based at least in part on the one or more characteristics associated with the one or more content items and the one or more attributes of the user, the plurality of content items having a common characteristic;
generate a content unit including the selected plurality of content items, the content unit including a display area for presenting a selected content item and configured to present an alternative selected content item in the display area in response to detecting a user interaction with the content unit; and
communicate the content unit to a client device for presentation to the user.

18. The computer program product of claim 17, wherein the selected plurality of content items include one or more advertisements and one or more stories describing one or more actions associated with one or more additional users connected to the user via the online system.

19. The computer program product of claim 17, wherein the one or more characteristics associated with a content item are selected from a group consisting of: a geographic location, a topic, an event, a group, a time, and any combination thereof.

20. The computer program product of claim 17, wherein the one or more attributes associated with the user are selected from: a geographic location associated with the user, a time associated with the user, an event associated with the user, a group associated with the user, an interest associated with the user, and any combination thereof.

21. The computer program product of claim 17, wherein an attribute associated with the user is determined based at least in part on content provided to the online system by the user.

22. The computer program product of claim 17, wherein select the plurality of content items from the one or more content items based at least in part on the one or more characteristics associated with the one or more content items and the one or more attributes of the user comprises:
select a content item associated with at least a threshold number of characteristics having at least a threshold similarity to one or more attributes of the user.
